(19) United States
(12) Patent Application Publication
(10) Pub. No.: US 2025/0247661 A1
(43) Pub. Date: Jul. 31, 2025

(54) Stem-based Audio Processing for Reproduction of Audio on Consumer Devices

(71) Applicant: Waves Audio Ltd., Tel Aviv (IL)

(72) Inventors: Itai Neoran, Beit Hananya (IL); Matan Ben-Asher, Neve Monosson (IL); Itamar Davidesco, Beit-Hilkiya (IL)

(21) Appl. No.: 19/037,348

(22) Filed: Jan. 27, 2025

Related U.S. Application Data
(60) Provisional application No. 63/625,983, filed on Jan. 28, 2024.

(51) Int. Cl. H04S 7/00; H04S 3/00

(52) U.S. Cl. CPC H04S 7/30; H04S 3/008; H04S 2400/01; H04S 2400/13

(57) ABSTRACT

Rendering an audio stream with one or more channels in real time through one or more playing devices. Audio processing circuitry including an audio enhancement capable processor is configured to input the audio stream as an audio stream in digital format. Each channel of said audio stream is separated into a plurality of K audio stem streams. Audio enhancement processes adapted to respective contents of the K audio stem streams are applied to the K audio stem streams to produce processed audio stem streams. The processed audio stem streams are summed into an output audio stream of one or more audio channels to be rendered by the one or more playing devices.

### BACKGROUND

### 1. Technical Field

The present invention relates to aspects of real-time digital signal processing of audio streams and playing the processed audio stream over multiple channels.

### 2. Description of Related Art

Legacy films have a soundtrack including audio content classes, e.g. dialogue, music and ambience/sound effects previously recorded together, e.g in stereo with two microphones.

Separation of the original audio content into stems may be performed using one or more previously trained machines, e.g. neural networks. Representative references which describe separation of the original audio content into audio content classes using neural networks include:
Aditya Arie Nugraha, Antoine Liutkus, Emmanuel Vincent. Multichannel Music Separation with Deep Neural Networks. European Signal Processing Conference (EUSIPCO), Aug 2016, Budapest, Hungary. pp. 1748-1752._x005F_xffff_hal-01334614v2
S. Uhlich and M. Porcu and F. Giron and M. Enenkl and T. Kemp and N. Takahashi and YMitsufuji, “Improving music source separation based on deep neural networks through data augmentation and network blending.” 2017 IEEE International Conference on Acoustics, Speech and Signal Processing (ICASSP). IEEE, 2017

Various digital audio effects have been developed for composition, recording, mixing, and mastering of audio signals, as well as real-time interaction and sound processing. Audio effects may include: loudness, pitch and harmonicity, timbre, dynamic range compression (DRC), equalization (EQ) and spatial perception. Audio effects may be adapted based on one or more features of the input audio signals. Representative references follow which describe adaptive digital audio effects:
Vincent Verfaille, Udo Zölzer, Daniel Arfib. Adaptive digital audio effects (A-DAFx): a new class of sound transformations. IEEE Transactions on Speech and Audio Processing, 2006, 14 (5), pp. 1817-1831.10.1109/TSA.2005.858531. hal-00095922
Brandtsegg, Ø., 2015, November. A toolkit for experimentation with signal interaction. In Proceedings of the 18th International Conference on Digital Audio Effects (DAFx-15) (pp. 42-48). Norway: Trondheim.

### BRIEF SUMMARY

Various computerized systems and methods are described for rendering an audio stream with one or more channels in real time through one or more playing devices. Audio processing circuitry including an audio enhancement capable processor is configured to input the audio stream as an audio stream in digital format. Each channel of said audio stream is separated into a plurality of K audio stem streams. Audio enhancement processes adapted to respective contents of the K audio stem streams are applied to the K audio stem streams to produce processed audio stem streams. The processed audio stem streams are summed into an output audio stream of one or more audio channels to be rendered by the one or more playing devices. The output audio stream of one or more audio channels is streamed to the one or more playing devices. The audio enhancement processes may be further adapted to respective audio signals in the audio stem streams. The audio enhancement processes may be further adapted to a characteristic of the input audio data stream prior to stem separation. The audio enhancement processes may be further adapted to the one or more playing devices. At least one of said audio enhancement processes may include dynamic range compression, adapted to the respective audio content of at least one of the K audio stem streams. An amount of the dynamic range compression in said at least one audio stem stream may also be responsive to an input from a side-chain signal. The side-chain signal may be computed based on signals of one or more of the audio stem streams other than the at least one audio stem stream. In one example, the K audio stem streams may include a stem stream favoring musical content over speech content, and a stem stream favoring speech content over musical content, resulting in two or more separated audio streams. In another example, the K stem streams include a stem stream favoring instrumental accompaniment over singing, and a stem stream favoring singing over instrumental accompaniment, resulting in two or more separated audio streams.

Computer readable media are disclosed herein storing instructions for executing computerized methods as disclosed herein.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

The invention is herein described, by way of example only, with reference to the accompanying drawings, wherein:

FIGS. 1-6 illustrate flow diagrams of processes according to different embodiments of the present invention; and

FIG. 7 illustrates a simplified schematic block diagram of a computer system/audio processing circuitry, according to features of the present invention.

The foregoing and/or other aspects will become apparent from the following detailed description when considered in conjunction with the accompanying drawing figures.

### DETAILED DESCRIPTION

Reference will now be made in detail to features of the present invention, examples of which are illustrated in the accompanying drawings, wherein like reference numerals refer to the like elements throughout. The features are described below to explain the present invention by referring to the figures.

While sound mixing for motion pictures or for music production, audio content may be recorded as separate audio content classes, also referred to herein as “stems”. By way of example, these stems may be: dialogue, music and sound effects. Recording as stems facilitates replacing dialogue with foreign language versions and also adapting the soundtrack to different reproduction systems, e.g. monaural, binaural and surround sound systems.

By way of introduction, the present invention in different embodiments is directed to an audio driver and/or circuit enabling a computer system connectable to a network to receive an audio data stream in one or more channels, process the audio stream and play the processed audio data stream on one or more playing devices, e.g. loudspeakers.

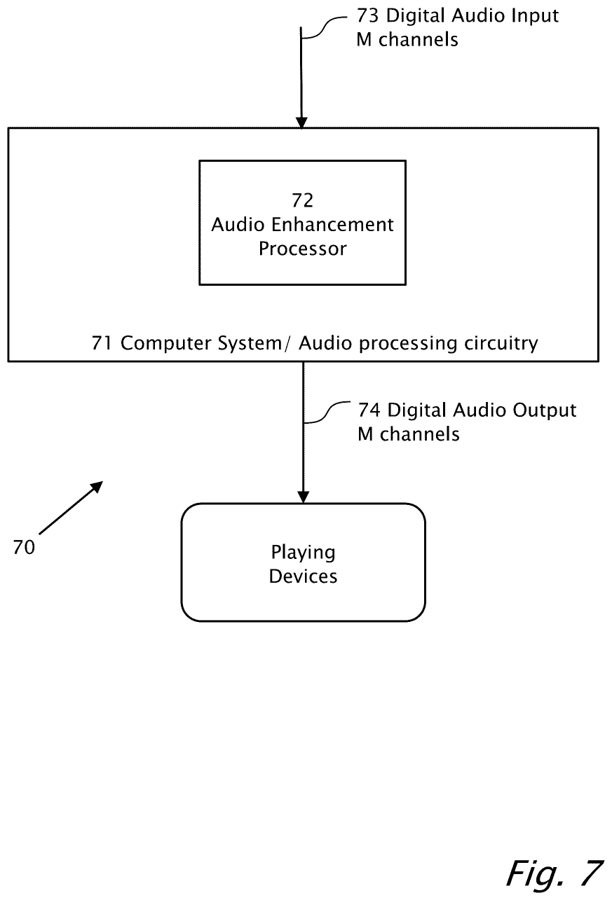

Referring now to the drawings, FIG. 7 is a simplified schematic block diagram 70 of a computer system/audio processing circuitry 71, according to features of the present invention. Computer system 71 includes an audio input 73 of M digital channels, an audio enhancement processor 72 and a digital audio output 74 of M digital channels. Digital audio output may be played in real-time on playing devices 75, by way of example stereo speakers for M=2 or surround speakers for M=5. Computer system 71 equipped with audio processing circuitry is capable of streaming, inputting M digital audio channels, performing audio enhancement and outputting enhanced M digital output channels 74 to playing devices 75.

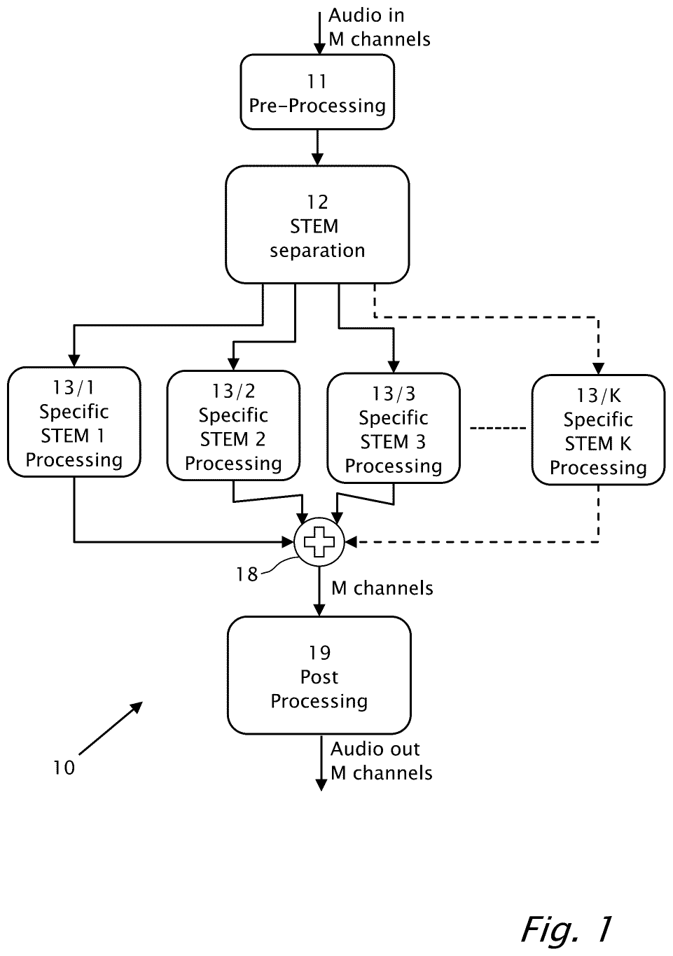

Reference is now made to FIG. 1 which illustrates flow of processing audio in M channels, according to features of the present invention. For each channel M, the input audio signal may be separated (step 12) into audio content classes or stems. The stems may undergo specific processing (13/1 . . . 13/K) which may depend on the stem (1 . . . K).

The specific processing may depend on the label, e.g. music,speech ambience/effects of the stem. After specific or individual processing of the stem, the channels may be mixed (step 18) or remixed, post processed (step 19) and played. The entire process 10 may be performed in a computer system during real-time streaming.

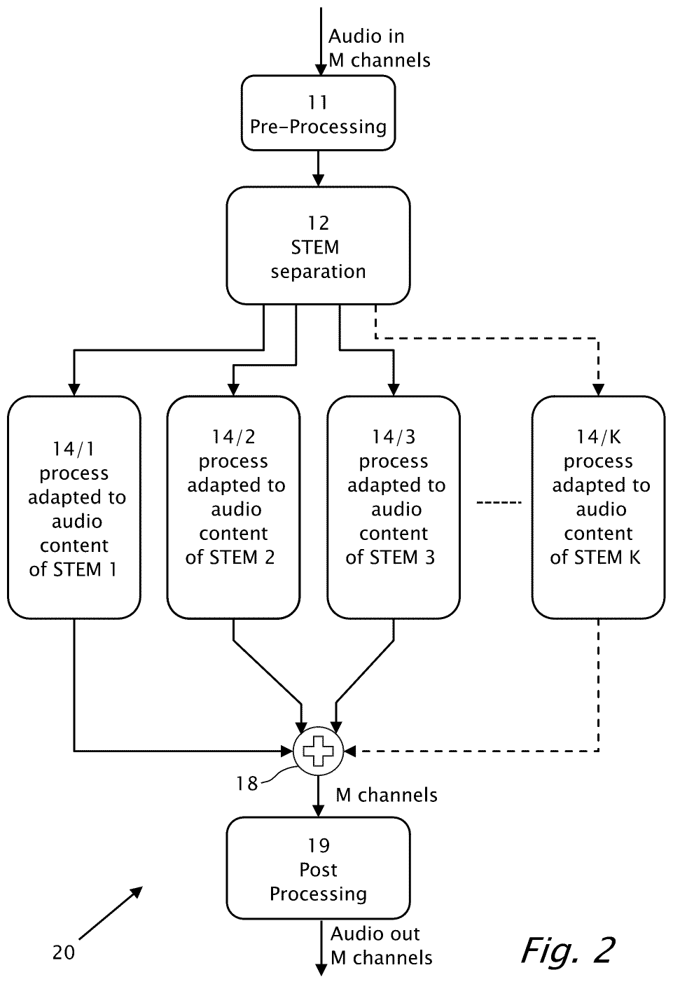

Reference is now made to FIG. 2 which illustrates flow of processing audio in M channels, according to features of the present invention. For each channel M, the input audio signal may be separated (step 12) into audio content classes or stems. The stems may undergo specific processing (14/1 . . . 14/K) which may be adapted to specific content on the stem (1 . . . K). Adaptation (step 14) to specific content may be performed by any mechanism known in the art of adapted audio effects. Adaptive digital audio effects (step 14/K) may include a time-varying control derived from time-varying sound features of stem K transformed into control values using specific mapping functions. After specific or individual processing of the stem, the channels may be mixed (step 18) or remixed, post processed (step 19) and played. The entire process 20 may be performed in a computer system during real-time streaming.

The specific stem processing and/or post processing may be in accordance with the computer system and the particular equipment (speakers, headphones) being used to play the remixed content.

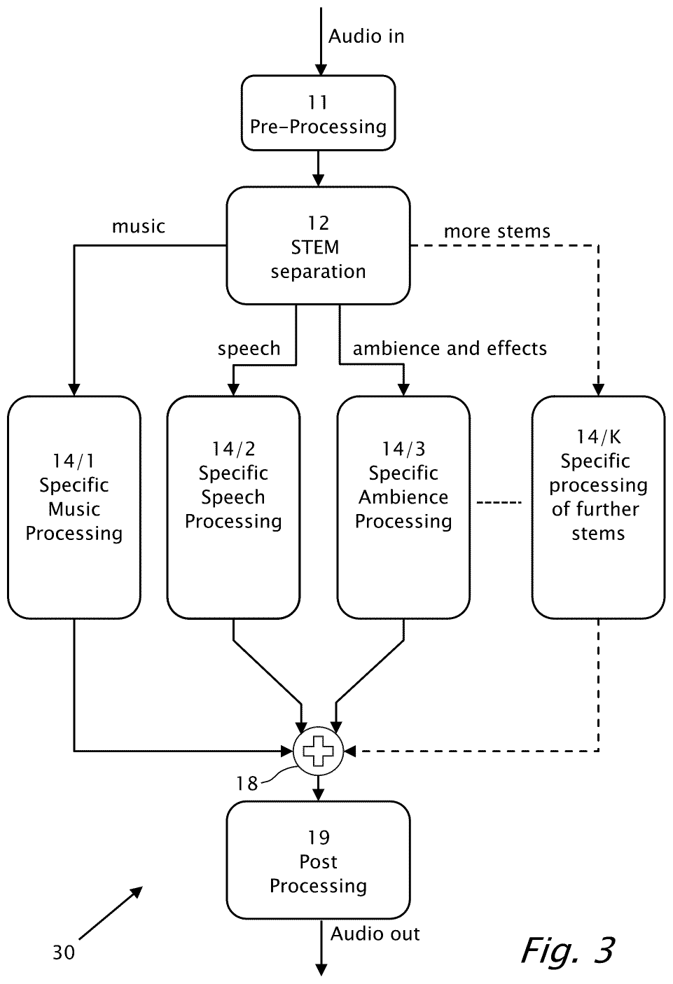

Reference is now made to FIG. 3 which illustrates flow of processing audio in M channels, according to features of the present invention in a specific example of the embodiment illustrated in FIG. 2. For each channel M, the input audio signal may be separated (step 12) into audio content classes or stems. The content in this example is cinematic and the stems are separated into: music, speech, ambience/special effects with the possibility of additional stems. The stems may undergo specific processing (14/1 . . . 14/K) which may be adapted to specific content on the stem (1 . . . K). Adaptation (step 14) to specific content may be performed by any mechanism known in the art of adapted audio effects. Adaptive digital audio effects (step 14/K) may include a time-varying control derived from sound features of stem K transformed into control values using specific mapping functions. For example, dynamic range compression (DRC) may be performed (step 14/2) on a stem containing speech derived from extracted statistical features from the speech. After specific or individual processing of the stem, the channels may be mixed (step 18) or remixed, post processed (step 19) and played. The entire process 20 may be performed in a computer system during real-time streaming.

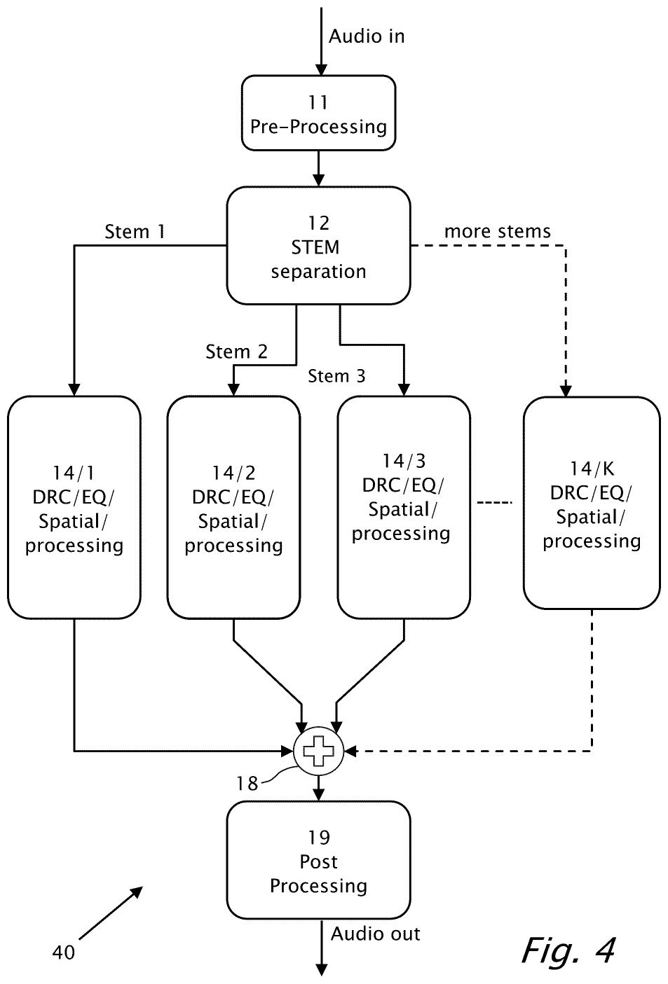

Reference is now made to FIG. 4, which illustrates features according to the present invention. Audio input of M channels may be separated (step 12) into three (or more) stems including a first stem, STEM 1, a second stem STEM 2 and third stem STEM 3. In some cases, the audio input may be separated (step 12) into additional stems. The stems may be specifically processed (steps 14/1 . . . 14/K) with one or more of dynamic range compression, equalization and/or spatial two or three dimensional location of the sound source(s) in the stem. In the embodiment shown in FIG. 4, individual processing (steps 14/1 . . . 14/K) of the stems may be preset during the stream and user controls for modifying the individual processing are not available. After specific or individual processing of the stem, the channels may be mixed (step 18) or remixed, post processed (step 19) and played. The entire process 40 may be performed in computer system 70 during real-time streaming.

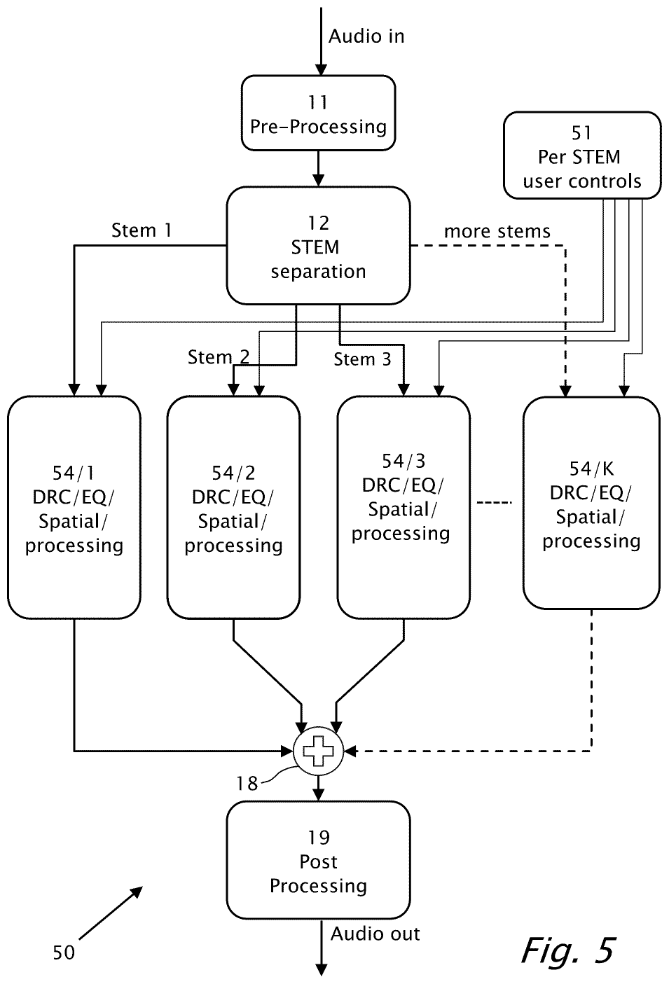

Reference is now made to FIG. 5, which illustrates further features according to the present invention. Audio input of M channels may be separated (step 12) into three (or more) stems including a first stem, STEM 1, a second stem STEM 2 and third stem STEM 3. In some cases, the audio input may be separated (step 12) into additional stems. The stems may be specifically processed (steps 54/1 . . . 54/K) with one or more of dynamic range compression, equalization and/or spatial two or three dimensional location of the sound source(s) in the stem. In the embodiment shown in FIG. 5, individual processing of the stems may be preset during the stream and user controls (step 51) for modifying the individual processing of the respective stems are available. After specific or individual processing (steps 54/1 . . . 54/K) of the stem, the channels may be mixed (step 18) or remixed, post processed (step 19) and played. The entire process 50 may be performed in computer system 70 during real-time streaming.

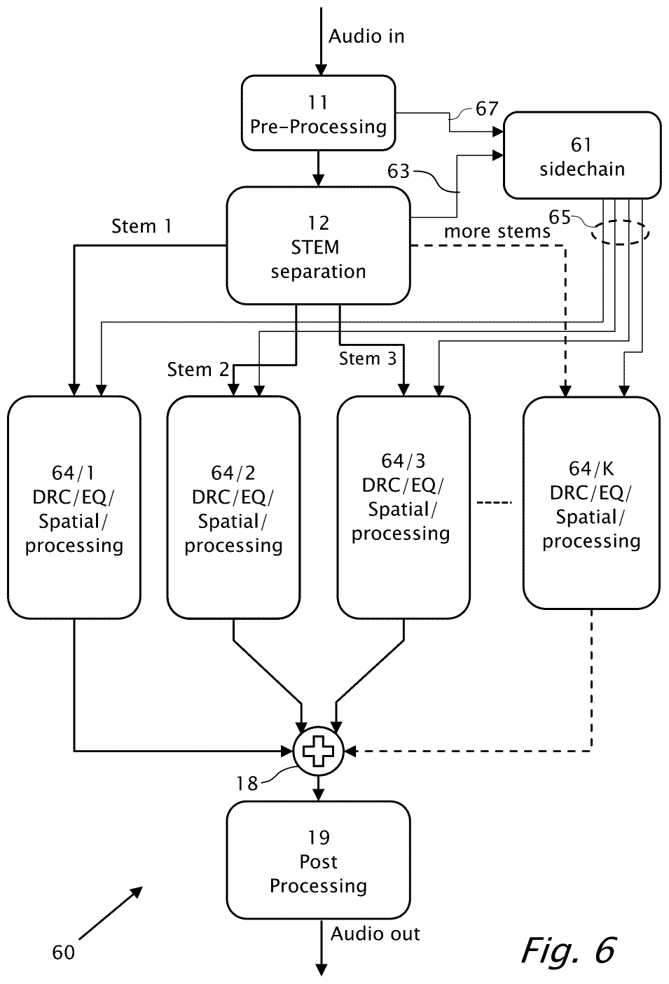

Reference is now made to FIG. 6, which illustrates further features according to the present invention. Audio input of M channels may be separated (step 12) into three (or more) stems including a first stem, STEM 1, a second stem STEM 2 and third stem STEM 3. In some cases, the audio input may be separated (step 12) into additional stems. The stems may be specifically processed (steps 64/1 . . . 64/K) with one or more of dynamic range compression, equalization and/or spatial two or three dimensional location of the sound source(s) in the stem. In the embodiment shown in FIG. 6, dynamic range compression of the stems may be implemented and controlled using respective side chains.

Side chain outputs 65 into the dynamic range compression algorithms per stem may depend on characteristics 67 of the input audio prior to stem separation. The side chain inputs may be derived from each stem, and/or a combination of measurements on other stems or on the full-mix.

After specific or individual processing (steps 64/1 . . . 64/K) of the stem, the channels may be mixed (step 18) or remixed, post processed (step 19) and played. The entire process 60 may be performed in computer system 70 during real-time streaming.

The embodiments of the present invention may comprise a general-purpose or special-purpose computer system including various computer hardware components Embodiments within the scope of the present invention also include computer-readable media for carrying or having computer-executable instructions, computer-readable instructions, or data structures stored thereon. Such computer-readable media may be any available media, transitory and/or non-transitory which is accessible by a general-purpose or special-purpose computer system. By way of example, and not limitation, such computer-readable media can comprise physical storage media such as RAM, ROM, EPROM, flash disk, CD-ROM or other optical disk storage, magnetic disk storage or other magnetic or solid state storage devices, or any other media which can be used to carry or store desired program code means in the form of computer-executable instructions, computer-readable instructions, or data structures and which may be accessed by a general-purpose or special-purpose computer system. The computer system generally includes input/output devices including a keyboard, mouse, display, audio circuits and/or drivers for inputting an audio signal from a microphone and playing an audio signal on playing devices such as headphones and/or speakers.

In this description and in the following claims, a “network” is defined as any architecture where two or more computer systems may exchange data. The term “network” may include wide area network, Internet local area network, Intranet, wireless networks such as “Wi-Fi”, virtual private networks, mobile access network using access point name (APN) and Internet. Exchanged data may be in the form of electrical signals that are meaningful to the two or more computer systems. When data is transferred or provided over a network or another communications connection (either hard wired, wireless, or a combination of hard wired or wireless) to a computer system or computer device, the connection is properly viewed as a computer-readable medium. Thus, any such connection is properly termed a computer-readable medium. Combinations of the above should also be included within the scope of computer-readable media. Thus, computer readable media as disclosed herein may be transitory or non-transitory. Computer-executable instructions comprise, for example, instructions and data which cause a general-purpose computer system or special purpose computer system to perform a certain function or group of functions.

The term “server” as used herein, refers to a computer system including a processor, data storage and a network adapter generally configured to provide a service over the computer network. A computer system which receives a service provided by the server may be known as a “client” computer system.

The term “sound effects” as used herein refers to artificially created sound or an enhanced sound used to set mood, simulate reality or create an illusion in a motion picture. The term “sound effect” as used herein includes “foleys” which are sounds added to a production to provide a more realistic sense to the motion picture.

The term “source” or “audio source” as used herein refers one or more sources of sound in a recording. Sources may include vocalists, actors/actresses, musical instruments and sound effects, which may be sourced in recordings or synthesized

The term “content” as used herein refers to data related to the audio source that is in any way meaningful to the targeted user

The term “audio content class” as used herein refers to a classification of audio sources which may depend on the type of content, by way of example (i) dialogue (ii) music, and (iii) sound effects are suitable audio content classes for an audio track of a motion picture. Other audio content classes may be contemplated depending on type content, for instance: strings, woodwinds, brass and percussion for a symphony orchestra. The term “stem” and “audio content class” are used herein interchangeably.

The term “channels” refers to monaural or mono (M=1), stereophonic or stereo (M=2) or greater number of channels such as surround (M=5), by way of example.

The term “stereo” as used herein refers to sound recorded with two microphones left and right and rendered with at least two output channels, left and right.

The term “side-chain” as used herein refers to an audio signal path that is separate from a main signal path. In audio processing, side-chaining allows the behavior of one audio signal (the main signal) to be controlled by another signal (the side-chain signal). For example, in a compressor, the side-chain can control when and how much the compressor affects the main audio signal based on the characteristics of another signal.

The indefinite articles “a”, “an” is used herein, such as “a channel”, “a stem” have the meaning of “one or more” that is “one or more channels” or “one or more stems”.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

Although selected features of the present invention have been shown and described, it is to be understood the present invention is not limited to the described features.

The claimed invention is:

1. A method for rendering an audio stream of one or more channels in real time through an audio enhancement capable processor to one or more playing devices, the method performable by the processor, the method comprising inputting to the processor, the audio stream in digital format, said processor configured to perform at least:
separating each channel of said audio stream into a plurality of K audio stem streams;
applying to the K audio stem streams, a respective plurality of audio enhancement processes adapted to respective contents of the K audio stem streams, thereby producing a plurality of processed audio stem streams;
summing one or more of said processed audio stem streams into an output audio stream of one or more audio channels to be rendered by the one or more playing devices; and
streaming the output audio stream of one or more audio channels to the one or more playing devices.

2. The method for rendering an audio stream of claim 1, wherein the audio enhancement processes are further adapted to respective audio signals in the audio stem streams.

3. The method for rendering an audio stream of claim 1, wherein the audio enhancement processes are further adapted to a characteristic of the input audio data stream prior to stem separation.

4. The method for rendering an audio stream of claim 1, wherein the audio enhancement processes are further adapted to the one or more playing devices.

5. The method for rendering an audio stream of claim 1, wherein at least one of said audio enhancement processes includes dynamic range compression, adapted to the respective content of at least one of the K audio stem streams.

6. The method for rendering an audio stream of claim 5, further comprising:
computing a side-chain signal based on signals of one or more of the audio stem streams other than said at least one audio stem stream; wherein an amount of the dynamic range compression in said at least one audio stem stream is also responsive to an input from said side-chain signal.

7. The method for rendering an audio stream of claim 1, wherein said K stem streams include at least one stem stream favoring musical content over speech content, and at least one stem stream favoring speech content over musical content, resulting in two or more separated audio streams.

8. The method for rendering an audio stream of claim 1, wherein said K stem streams include at least one stem stream favoring instrumental accompaniment over singing, and at least one stem stream favoring singing over instrumental accompaniment, resulting in two or more separated audio streams.

9. A non-transitory computer readable storage medium containing program instructions, which when read by a processor, cause the processor to perform a method of rendering an audio stream of one or more channels in real time through an audio enhancement capable processor to one or more playing devices, the method comprising inputting to the processor, the audio stream as an audio stream in digital format, said processor configured to perform at least:
separating each channel of said audio stream into a plurality of K audio stem streams;
applying to the K audio stem streams, a respective plurality of audio enhancement processes adapted to respective contents of the K audio stem streams, thereby producing a plurality of processed audio stem streams;
summing one or more of said processed audio stem streams into an output audio stream of one or more audio channels to be rendered by the one or more playing devices; and
streaming the output audio stream of one or more audio channels to the one or more playing devices.

10. A computer system, connectable to a network, the computer system comprising audio processing circuitry for rendering an audio stream of one or more channels in real time, the audio processing circuitry including an audio enhancement capable processor configured to:
input the audio stream as an audio stream in digital format;
separate each channel of said audio stream into a plurality of K audio stem streams;
apply to the K audio stem streams, a respective plurality of audio enhancement processes adapted to respective contents of the K audio stem streams, to produce a plurality of processed audio stem streams;
sum one or more of said processed audio stem streams into an output audio stream of one or more audio channels to be rendered by the one or more playing devices;
stream the output audio stream of one or more audio channels to the one or more playing devices.

11. A computer system of claim 10, wherein the audio enhancement processes are further adapted to respective audio signals in the audio stem streams.

12. A computer system of claim 10, wherein the audio enhancement processes are further adapted to a characteristic of the input audio data stream prior to stem separation.

13. A computer system of claim 10, wherein the audio enhancement processes are further adapted to the one or more playing devices.

14. A computer system of claim 10, wherein at least one of said audio enhancement processes includes dynamic range compression, adapted to the respective audio content of at least one of the K audio stem streams.

15. A computer system of claim 14, wherein an amount of the dynamic range compression in said at least one audio stem stream is also responsive to an input from a side-chain signal, wherein the side-chain signal is computed based on signals of one or more of the audio stem streams other than said at least one audio stem stream.

16. A computer system, of claim 10, wherein said K audio stem streams include at least one stem stream favoring musical content over speech content, and at least one stem stream favoring speech content over musical content, resulting in two or more separated audio streams.

17. A computer system, of claim 10, wherein said K stem streams include a stem stream favoring instrumental accompaniment over singing, and a stem stream favoring singing over instrumental accompaniment, resulting in two or more separated audio streams.
